(19) United States
(12) Patent Application Publication
(10) Pub. No.: US 2005/0183023 A1
(43) Pub. Date: Aug. 18, 2005

(54) Displaying and operating methods for a table-shaped information terminal

(76) Inventors: Yukinobu Maruyama, Kokubunji (JP); Takeshi Hoshino, Kodaira (JP); Takeshi Minemoto, Kawasaki (JP); Yuuichi Kurosawa, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,936

(22) Filed: Jan. 5, 2005

(30) Foreign Application Priority Data
Feb. 12, 2004 (JP) 2004-035159

(51) Int. Cl. G06F 3/00

(52) U.S. Cl. 715/759; 715/753; 715/751

(57) ABSTRACT

An individual information screen is displayed for each of operators on the same table surface and it is possible to surely acquire shared information required for conversation between the operators. The data on each of individual information screens cannot be viewed by the other operators. A shared information screen and a plurality of individual information screens are displayed in a display surface arranged on a table surface. The individual information screens are used by each operator and display individual information on each of the operators. Among the individual information displayed on each individual information screen, those which can be viewed by the other operators may be displayed as shared information on the shared screen by a predetermined operation on the respective individual information screen. It becomes possible to display the individual information screens at predetermined positions at arbitrary positions on the table surface.

### INCORPORATION BY REFERENCE

The present application claims priority from Japanese application JP2004-035159 filed on Feb. 12, 2004, the content of which is hereby incorporated by reference into this application.

### BACKGROUND OF THE INVENTION

This invention relates to a table-shaped information terminal used for business negotiation, conference, consultation, or the like and in particular, to a table-shaped information terminal display/operation method capable of viewing an information display screen on a table surface.

For example, W097/35248 PCT (U.S. Pat. No. 6,396,506) discloses a technique including a plurality of displays such as liquid crystal displays and plasma displays on a surface of table-shaped chassis (table surface), so that these display screens display necessary information to be used clients participating in business negotiation, conference, or the like.

In such a technique, since information is displayed and provided for each of the clients at the same table, each client can display necessary information (individual information) on the display screen assigned to him/her. However, in the business negotiation, conference, or consultation in which a plurality of clients converse with one another, there is common information (shared information) for the conversation and it is preferable that each client grasp the shared information for performing conversation.

For this, each client should display this shared information on the display surface (hereinafter, referred to as an individual information screen) assigned to him/her. If a client forgets operation for display, he/she cannot grasp the shared information and may have trouble with conversion. Moreover, a client may not understand which is the shared information required for the current conversation. When personal information is displayed on this screen, this information may be viewed by the other clients.

### SUMMARY OF THE INVENTION

It is therefore an object of the present invention to provide a table-shaped information terminal operation/display method capable of surely acquiring shared information without requiring operation by each client.

In order to achieve the aforementioned object, the present invention displays individual information screens and a shared information screen which can be operated by a plurality of screen operations, on a flat table surface of the table and makes it possible that the individual information displayed on the individual information screen is displayed on the shared information screen.

Moreover, in this invention, the individual information screen and the share information screen are displayed in indentations arranged on the table surface and the shared information screen is slightly inclined in the concave so that it is directed toward the individual information screen side.

Moreover, in this invention, individual information screens which can be operated by a plurality of screen operations are displayed on the flat table surface of the table, s shared display having a display surface almost vertical to the table surface is arranged to display shared information on the display screen, and individual information displayed on the individual information screen can be displayed as shared information on the shared information screen. The shared display has a display surface having a front side and a rear side and can be selectively set to a state in which the display surface is almost vertical to the table surface and a state in which the share display is on the table surface and the display surface is parallel to the table surface. Furthermore, the table surface has approach detection means having a single display surface for detecting that an operator operating the individual information screen has approached. An individual information screen is displayed at a position opposing to the operator approach position detected by the approach detection means. Furthermore, when operators who have approached the table surface are apart from each other by a distance greater than a predetermined value, the individual information screens are displayed on the table surface for each of the operators.

Moreover, in the present invention, the individual information screen includes means for narrowing the angle of field of view so that the individual information displayed on the individual information cannot be viewed by an operator of the other individual information screen.

Similarly, means for narrowing the angle of field of view corresponding to the number of the individual information screens which can be displayed are movably arranged on the table surface, so that the means for narrowing the angle of field of view are moved and positioned at the position where the individual information screens are displayed on the table surface.

Moreover, in this invention, one of the individual information screens is a particular individual information screen which is displayed on the table surface by power ON operation and by the screen operation of this particular individual information screen, the other individual information screens and the shared information screen are displayed.

According to this invention, operators can display necessary individual information in the respective individual information screens and the individual information can be provided by its owner to a partner operator by displaying it on the shared information screen when required. Moreover, the individual information of the respective individual information screens cannot be viewed by the other operators. Accordingly, each operator and display necessary individual information on his/her individual information screen without worrying about partners. Thus, it is possible to smoothly perform business negotiation, consultation, conference, and the like.

### BRIEF DESCRIPTION OF THE DRAWINGS

Figs. 1A and 1B are perspective views showing a table-shaped information terminal display/operation method according to a first embodiment of the present invention.

FIGS. 2A through 2C show display examples of the individual information screens in the first embodiment shown in FIG. 1.

FIGS. 3A and 3B are cross sectional views of a specific example of the essential part configuration of the individual information screen in FIG. 1 and FIG. 2.

FIGS. 4A and 4B are cross sectional views of another specific example of the essential part configuration of the individual information screen in FIGS. 1A and 1B and FIGS. 2A through 2C.

FIGS. 5A and 5B are perspective views of modified example of the first embodiment shown in FIGS. 1A and 1B.

FIG. 6 is a block diagram showing a specific example of the internal circuit configuration of the table-shaped information terminal shown in FIG. 1.

FIG. 7 is flowchart showing a specific example of the operation and operation procedure in the first embodiment shown in FIG. 1.

FIG. 8A shows a part of flow of the individual information screens and the shared screen according to the operation and operation procedure shown in FIG. 7.

FIG. 8B shows a part of flow of the individual information screens and the shared screen continuing after FIG. 8A.

FIG. 8C shows a part of flow of the individual information screens and the shared screen continuing after FIG. 8B.

FIGS. 9A and 9B show another specific example of passing the shared information between the individual information screen and the shared screen among the screen operations shown in FIG. 7 and FIGS. 8A through 8C.

Figs. 10A and 10B are perspective views showing a table-shaped information terminal display/operation method according to a second embodiment of the present invention.

FIG. 11 is a perspective view showing a table-shaped information terminal display/operation method according to a third embodiment of the present invention.

FIGS. 12A through 12C show display examples of the individual information screen in the third embodiment shown in FIG. 11.

FIGS. 13A and 13B show specific examples of a method for setting a field-of-view angle control filter for the individual information screen in the third embodiment shown in FIG. 11.

FIG. 14 is a block diagram showing a specific example of an internal circuit configuration of the table-shaped information terminal shown in FIG. 11.

### DETAILED DESCRIPTION OF THE EMBODIMENTS

Description will now be directed to embodiments of the present invention with reference to the attached drawings.

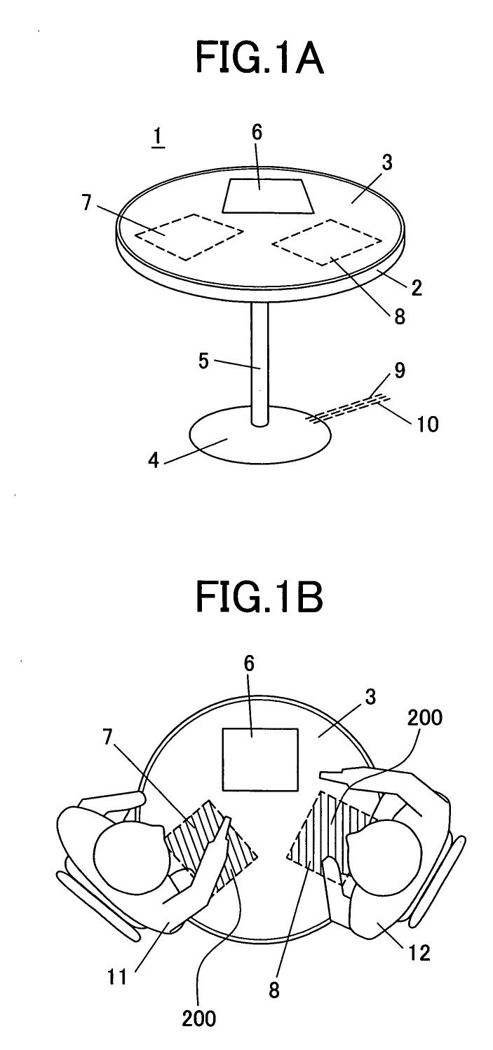

FIGS. 1A and 1B shows a table-shaped information terminal display/operation method according to a first embodiment of the present invention. FIG. 1A is a perspective view and FIG. 1B is a view from above. A reference symbol 1 denotes a table-shaped information terminal, 2 denotes a communication table, 3 denotes a table surface, 4 denotes a stand base section, 5 denotes a leg, 6 denotes a shared information screen, 7 and 8 denote individual information screen, 9 denotes a power cable, 10 denotes a network cable, and 11, 12 denote operators.

In the figures, the table-shaped information terminal 1 has the communication table 2 of a disc shape, for example, attached onto the leg 5 embedded into the stand base section 4. On the table surface 3 of this communication table 2, the shared information screen 6 and, for example, the two individual information screen 7, 8 are displayed for use.

When the individual information screens 7, 8 are displayed, as shown in FIG. 1B, the operators 11, 12 sit in front of the screens so as to observe the image displayed on the individual information screens 7, 8. The individual information screens 7, 8 have a tough panel functions so that tough operation can be performed on the individual information screens 7, 8. Moreover, the shared information screen 6 is displayed by the operation on the individual information screens.

It should be noted that the shared information screen 6 and the individual information screens 7, 8 enter a usable state by turning ON a power switch (not depicted) at the table-shaped information terminal 1 or operating a remote controller to turn ON power. Here, an example is given on a case that a bank staff converses with a client to answer a consultation. The individual information screen 7 is for the bank staff while the individual information screen 8 is for the client. In this case, when the power is turned ON, the individual information screen 7 for the bank staff is displayed and when touch operation is performed on this individual information screen 7, the shared information screen 6 and the individual information screen are displayed. However, the table-shaped information terminal 1 can also be used in the field other than the bank. According to the field including the bank, the power may be turned ON by turning ON the power source or by turning ON the power by using a remote controller, so that the shared information screen 6 and the individual information screen 7, 8 are displayed. It is also possible to use a sensor (not depicted) which detects a person who approaches the communication table 2, judges the person in a predetermined range to be an operator of the individual information screen in the vicinity of the range, and displays the individual information screen. In this case, when one of the individual information screen is displayed, the shared information screen 6 is also displayed. Moreover, the number of the individual information screen is not limited to two.

Here, each of the individual information screens 7, 8 has a narrow angle of field of view. That is, the field of view of the individual information screen 7 is limited to a narrow angle so that only the operator 11 who is sitting in front of the individual information screen 7 can view the display image of the individual information screen 7 and the operator 12 sitting in front of the adjacent individual information screen 8 cannot view the display image of the individual information screen 7. Similarly, the field of view of the individual information screen 8 is set to a narrow angle so that only the operator 11 sitting in front of the individual information screen 7 can view the display image. Accordingly, the individual information screen 7 can display information (individual information) to be viewed only by the operator 11 who views and operates the information. Similarly, the individual information screen 8 can display the information (individual information) to be viewed only by the operator 12. In order to display such individual information it is necessary to authenticate the operators 11, 12.

On the contrary, the shared information screen 6 displays an image of information (shared information) to be viewed by the both operators 11, 12 and has a wide angle of field of view so that the both of the operators 11, 12 sitting in front of the individual information screen 7, 8, respectively, for observing and operating the individual information can observe the display screen of the shared information displayed on the shared information screen 6.

It should be noted that in this table-shaped information terminal 1, the power cable 9 and network cable 10 pass through the floor and is lead to the communication table 3 via the leg 5 from the stand base 4. Power is supplied to the table-shaped information terminal 1 via this power cable and information is transmitted and received to/from a server via the network cable 10. The transmission and reception of information can also be performed by radio waves. In such a case, the network cable 10 is not required.

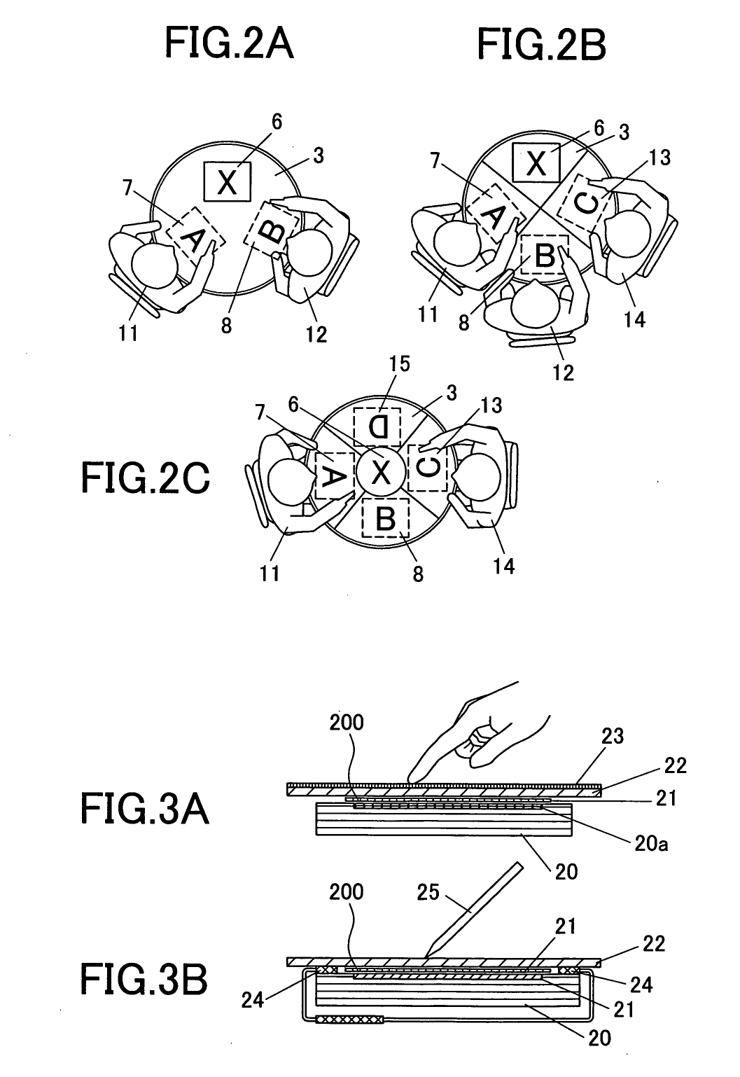

Like FIGS. 1A and FIG. 1B, FIG. 2A shows a table surface 3 on which two individual information screens 7,8 can be displayed. (It should be noted that X represents a display screen of shared information displayed on the shared information screen 6 and A, B represent display screens of the individual information displayed by the individual information screens 7, 8, respectively). As shown in FIG. 2B, three individual information screens 7, 8, 13 can also be displayed. In this case, the communication table 3 is divided into four equal areas and in each of the four areas, the shared information screen 6 and the individual information screen 7, 8, 13 are displayed. (It should be noted that C represents a display screen of individual information displayed by the individual information screen 13). The individual information screens 7, 8, 13 are displayed in such directions that the respective operators 11, 12, 14 sitting toward the direction of the shared information screen 6 can view the information screens 76, 8, 13 from the front, respectively. Thus, for example, when the operator 11 sits toward the individual information screen 7, the operator 11 can view the shared information screen 6 in the front direction. The same apply to the operators 12, 14 of the individual information screens 8, 13. The operator 12 sitting between the operators 11 and 14 views the shared information screen 6 right in front while the operators 11 and 14 view the display screen X of the shared information in the shared information screen 6 not from right beside but in the oblique direction so that they can easily view the screen X of the shared information.

FIG. 2C shows the same communication table 3 having four individual information screens 7, 8, 13, 15. The center portion of this communication table 3 is made a display area of the shared information screen 6 and the remaining doughnut-shaped area is divided into four equal areas serving as display areas of the individual information screens 7, 8, 13, 15. (It should be noted that D represents a display screen of the individual information displayed by the individual information screen 15). In this case also, when the operators 11, 14 of the individual information display screen 7, 13 sandwiching the operator (not depicted) of the individual information device 8 observe and operate the individual information display screen 7, 13 from the front, they can view the display screen X of the shared information in the shared information screen 6 not from right beside but in the oblique direction so that they can easily view the screen X. The operator (not depicted) of the individual information screen 15 view the opposite side of the display screen X of the shared information in the shared information screen 6. In such a case, one of the operators operate through the individual information screen for performing screen inversion upside down or rotation by 90 degrees/180 degrees, so as to change the display direction of the shared information screen 6 so that each operator can easily view the shared information screen 6.

FIGS. 3A and 3B are cross sectional views showing a specific example of the essential portion configuration of the individual information screens 7, 8, 13, 15. A reference symbol 20 denotes a display unit, 20a denotes a display surface, 21 denotes a field-of-view angle control filter, 22 denotes a protection panel, 23, 24 denote touch sensor portions, and 25 denotes a pen position detection section. The field-of-view angle filter 21 may have a configuration as an example that as shown in FIG. 1B and FIGS. 3A and 3B, a plurality of light-shading plates 200 are arranged to be vertical to the screen surface so that each operator cannot see the screens of the other operators.

FIG. 3A shows an-individual information screen having a touch panel function for touch operation by a finger tip. The field-of-view angle control filter 21 is arranged on the display surface 20a of the display unit 20 such as a CRT (cathode ray tube) and liquid crystal. In order to cover the display means having such configuration, the display protection panel 22 and the touch sensor section 23 are laminated over the entire communication table 2 (FIG. 1). The flat surface of the touch sensor section 23 is the table surface 3 (FIG. 1) of the communication table 2.

On the table surface 3, the display unit 20 is started and the display surface 20a is displayed as the individual information screens 7, 8, 13, 15. The information screen displayed on the display surface 20a is displayed as the display screens A, B, C, D of the individual information on the table surface 3.

The touch sensor section 23 may employ the electrostatic capacity method or the resistance film method capable of detecting a touch position when touched by a finger tip when the table surface 3 of the entire communication table is flat. In this case, the detection range of the touch position is defined by the range of the display surface 20a of the display unit 20.

Moreover, the field-of-view angle control filter 21 limits the light emission direction from the display surface 20a and includes, for example, a louver-shaped portion for bending the light spreading around so that the display contents of the display surface 20a cannot be viewed by the adjacent operators.

FIG. 3B shows a case of detecting a touch position touched by a stylus pen 25. The field-of-view angle control filter 21 is arranged on the display surface 20a of the display unit 20 and a pen position detection section 24 is provided along the side of the field-of-view angle control filter 21. The display protection panel 22 having a flat surface is arranged over the entire surface of the communication table 2 (FIG. 1) so as to cover the field-of-view angle control filter 21 and the pen position detection section 24. The surface of the display protection panel 22 serves as the table surface 3 (FIG. 1) of the communication table 2.

The touch panel using the stylus pen 25 may employ the electromagnetic induction method in which electric waves are successively generated from coils and the stylus pen has a synchronization circuit.

It should be noted that the shared information screen 6 has similar configuration but is different in that no field-of-view angle control filter is provided.

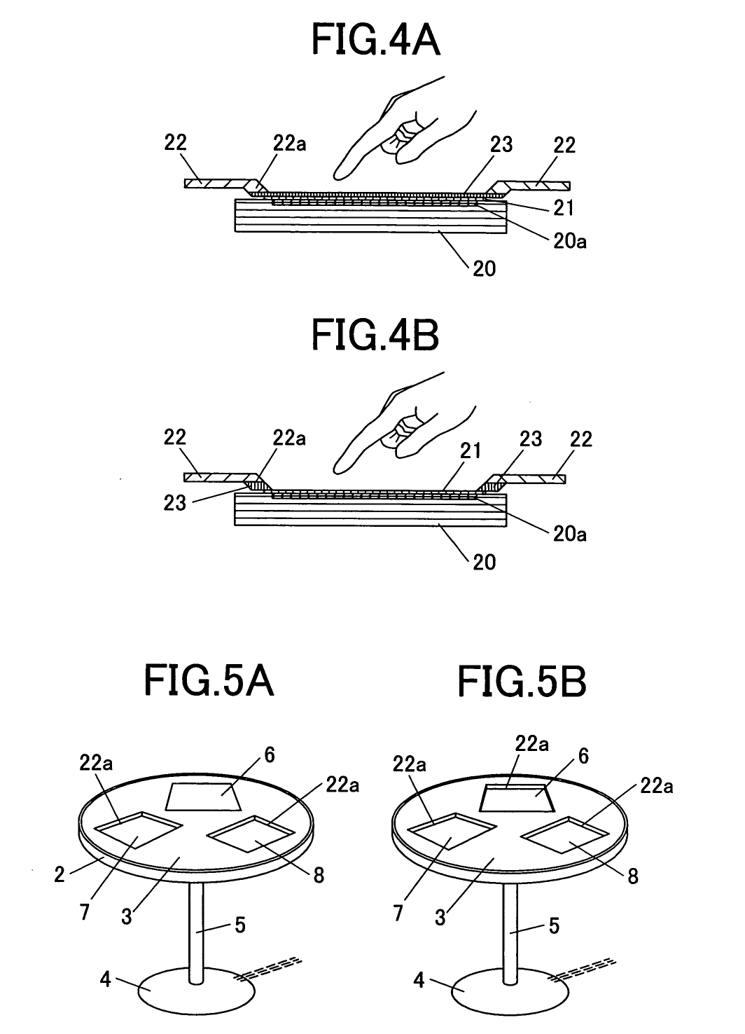

FIGS. 4A and 4B are cross sections showing another configuration of the touch panel function in the first embodiment for touch operation by a finger tip. It should be noted that like the specific examples shown in FIGS. 3A and 3B, the field-view-of angle control filter 21 is provided in the front surface of the display surface 20a of the display 20.

FIG. 4A shows a touch panel function of the pressure-sensitive method. The display protection panel 22 serves as the table surface 3 of the communication table 2 (FIG. 1). An opening 22a is formed at the portion opposing to the display surface 20a of the display protection panel 22. In the portion of the opening 22a, the pressure-sensitive touch sensor 23 is arranged so as to cover the field-of-view angle control filter 21 arranged in the front surface of the display surface 20a of the display 20.

Moreover, FIG. 4B shows a touch panel function of the infrared ray method. Similarly, an opening 22a is formed at the portion opposing to the display surface 20a of the display protection panel 22. At the end portion of the lower surface of the opening 22a, the touch sensor section 23 is arranged. In the touch sensor section, a light emitting element is arranged on one of the opposing sides and a light reception element is arranged on the other side, so that a plurality of infrared rays are emitted in the opening 22a so as to intersect one another.

Thus, when the opening 22a is provided at the portion of the display 20 of the display protection panel 22 serving as the table surface 3, as shown in FIG. 5A, on the table surface 3 of the communication table 2, the individual information screens 7, 8 are displayed in the indentations formed by the opening 22a. The shared information screen 6 is displayed almost in the same plane as the table surface 3a like the configuration of FIG. 3 so that the operators of the individual information screens 7, 8 can easily operate and can easily view the display screen of the shared information displayed there. However, as shown in FIG. 5B, it is also possible to provide an indentation formed by an opening 22a and slightly incline the display screen toward the operators so that it can be viewed easily.

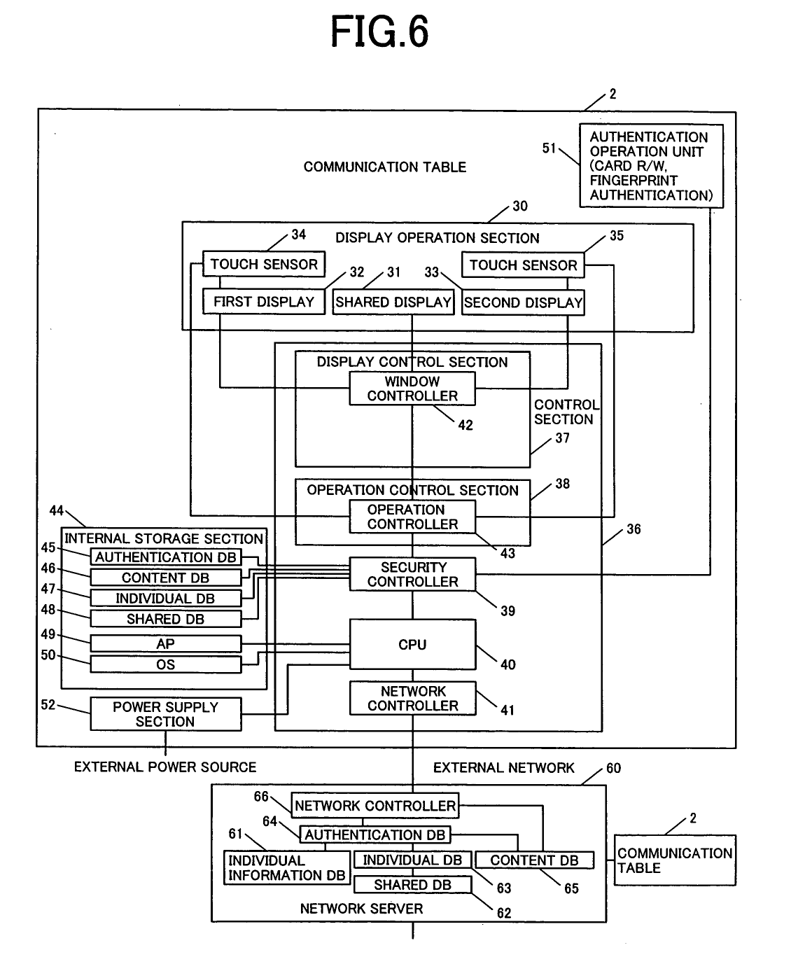

FIG. 6 is a block diagram showing an example of a circuit arranged in the communication table shown in FIG. 1. A reference symbol 30 denotes a display operation section, 31 denotes a shared display, 32 denotes a first display for displaying individual information (corresponding to the display 20 in FIG. 3 and FIG. 4), 33 denotes a second display for displaying individual information (corresponding to the display 20 in FIG. 3 and FIG. 4), 34, 35 denote touch sensors (corresponding to the touch sensor sections 23, 24 in FIG. 3 and FIG. 4), 36 denotes a control section, 37 denotes a display control section, 38 denotes an operation control section, 39 denotes a security controller, 40 denotes a CPU (central processing unit), 41 denotes a network controller, 42 denotes a window controller, 43 denotes an operation controller, 44 denotes an internal storage section, 45 denotes an authentication DB (database), 46 denotes a content DB, 47 denotes a individual information DB, 48 denotes a shared information DB, 49 denotes application software (AP), 50 denotes an operating system (OS), 51 denotes an authentication operation unit, 52 denotes power supply section, 60 denotes a network server, 61 denotes an individual information DB, 62 denotes a shared information DB, 63 denotes an individual information DB, 65 denotes a content DB, and 66 denotes a network controller.

In FIG. 6, the communication table 2 includes the display operation section 30, the control section 36, the internal storage section 44, the authentication operation unit 51, and power supply section 52.

The display operation section includes the shared display 31, the first display 32 for displaying individual information having the touch sensor 34, and the second display 32 for displaying individual information having the touch sensor 35. The first display 32 displays the individual information screen 7 in FIG. 1 and the second display 33 displays the individual information screen 8 in FIG. 1. Moreover, the shared display 31 displays the shared information screen 6 in FIG. 1. Here, it does not have the touch panel function but it may have this function.

The control section 36 includes the display control section 37, the operation control section 38, the security controller 39, the CPU 40, and the network controller 41. The display control section 37 includes the window controller 42 or the like and controls the screen display of the shared display 31 and the first display 32, 33. The operation control section 38 includes the operation controller 43 for detecting a touch position from the touch operation detection outputs supplied from the touch sensors 34, 35, supplying the detection result to the CPU 40, and controlling the display control section 37 according to the instruction and information from the CPU 40.

The security controller 39 performs authentication of a client by acquiring personal information such as a password and IC card and information such as a fingerprint which have been inputted by the authentication operation unit 51 and correlating then with the authentication information stored in the authentication DB 45 of the internal storage section 44. By performing such an authentication, the CPU 40 reads the individual information for the current client from the individual information DB of the internal storage section 44 and controls the display control section 37 and the display operation (?) section 30, so as to display the individual information on the second display 33 for the client. It should be noted that once authentication is performed, this authentication is valid as lon as this second display 33 is used. According to the touch operation of the touch sensor 35, the individual information of the client authenticated is read out from the individual information DB 47 and displayed on the second display 33.

Moreover, when a bank staff performs touch operation of the touch sensor 34 of the first display 32, the CPU 40 controls the display control section 37 to set the shared display 31 and the second display 33 for the client to a display state and reads the shared information from the shared information DB of the internal storage section 44 to display it on the shared display 31.

It should be noted that when the power switch (not depicted) is turned ON or when power is turned ON from the power supply section 52 by the remote control operation, the CPU 40 acquires the OS 50 and the AP 49 from the internal storage section 44 and performs operation for controlling each component. In this case, firstly, the first display for a bank staff is set to the display state, and the top screen is read from the individual information DB 47 of the internal storage section 44 so as to be displayed on the first display. Thus, the individual information screen 7 in FIG. 1 is displayed.

Moreover, the CPU 40 can communicate with the network server 60 via an external network by using the network controller 41. The network server 60 includes the individual information DB 61, the shared information DB 62, the personal information DB 63, the authentication DB 64, the content DB 65, and the like. It is possible to transmit the information in these DB to the CPU 40 in the communication table 2 by the network controller 66. When the CPU 40 cannot cope with the information from the touch sensors 44, 45 and the authentication operation unit 51 by the DB in the internal storage section 44, it acquires necessary information from the network server 60 and use it. For example, when new individual information for the first display 332 for a bank staff is added to the individual information DB 63 of the network server 60, this is requested by the CPU 40 of the communication table 2 so that it is provided from the network server 60. Thus, information acquired from the network server 60 is added to the corresponding DB of the internal storage section 44.

It should be noted that the content stored in the content DB 46, 65 is, for example, information acquired by the Internet and used for business negotiation and consultation. Moreover, the individual information in the individual information DB 61 is information related to a client and stored in correlation with the individual information when stored in the individual information DB 47 in the internal storage section 44 of the communication table 2. Furthermore, this network server 60 can communicate with another communication table 2 and is shared by a plurality of communication tables 2.

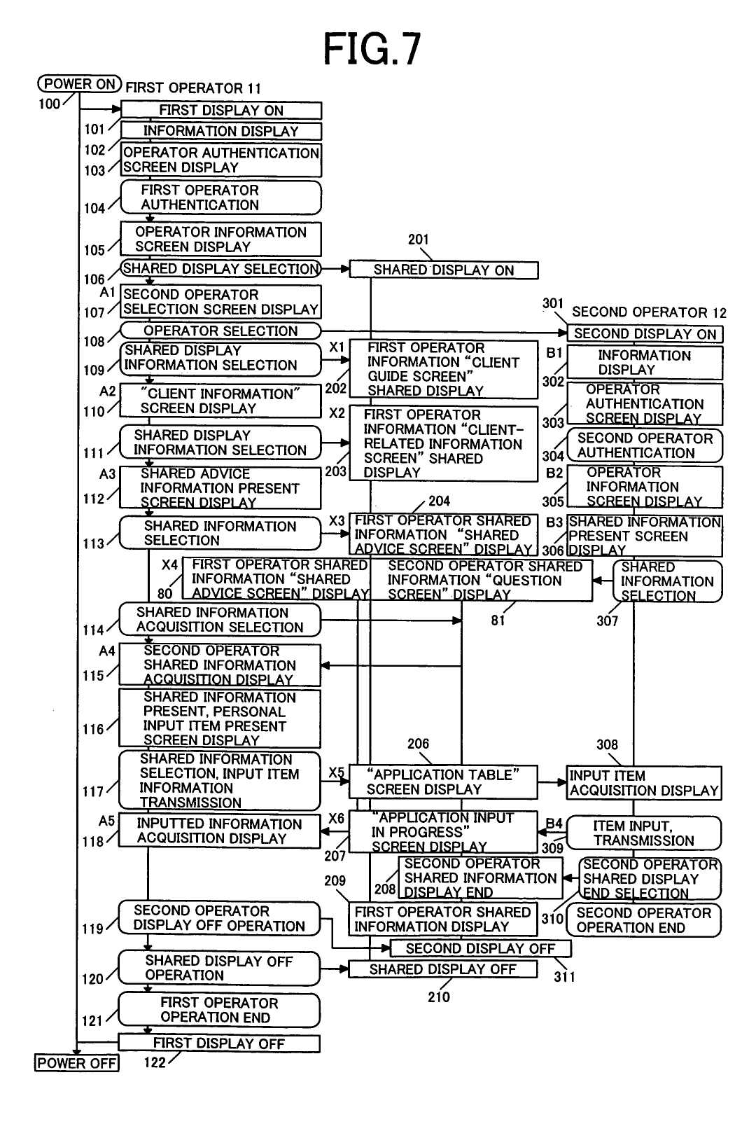

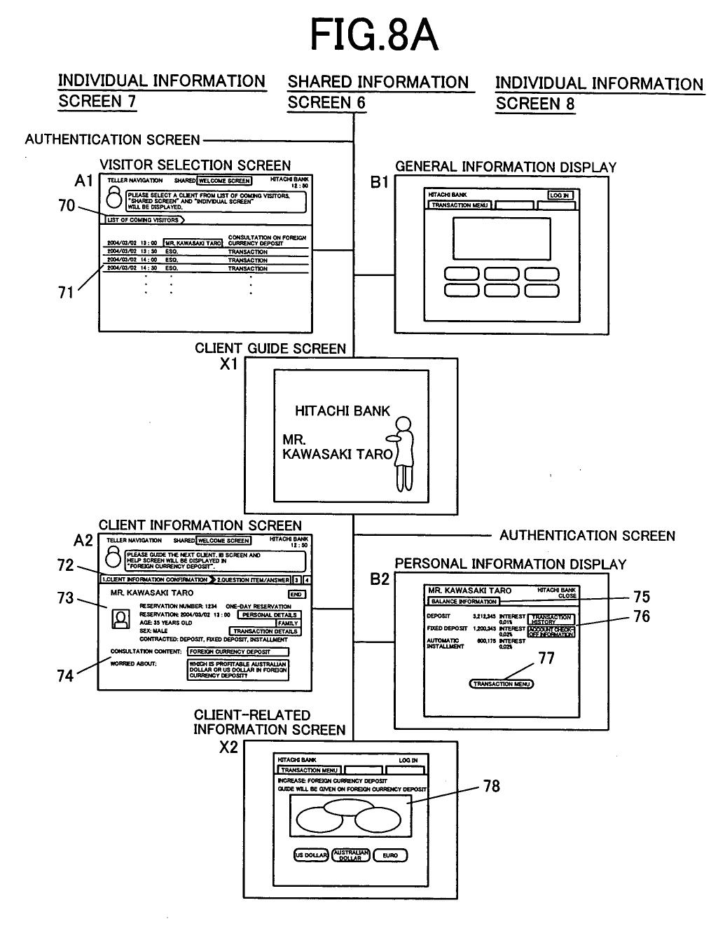

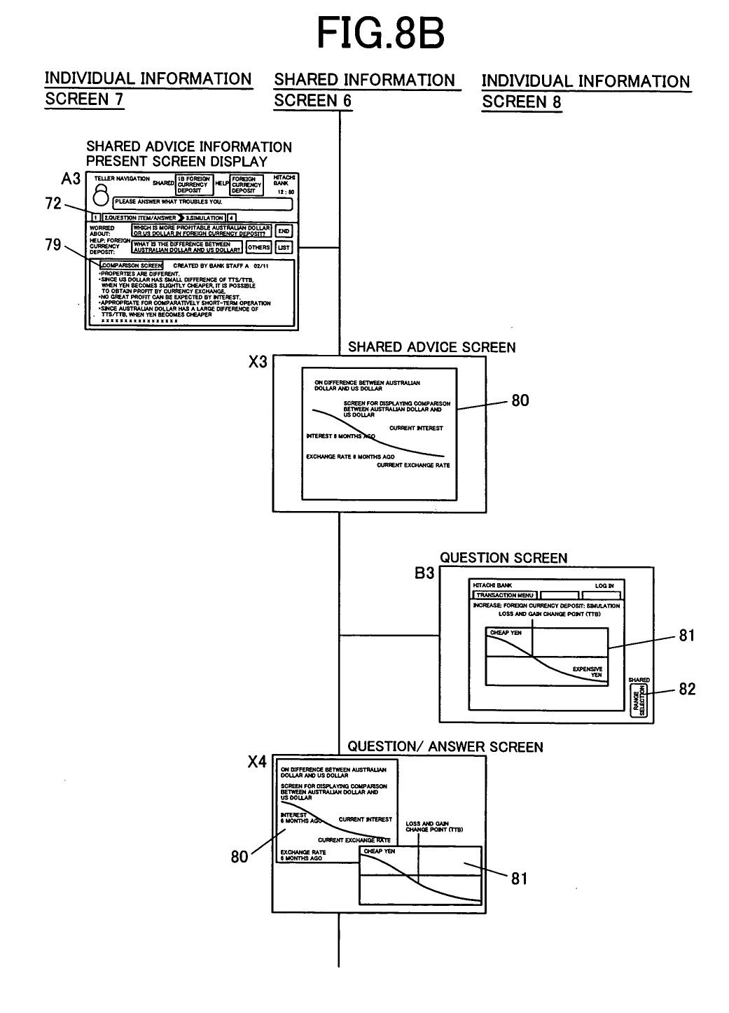

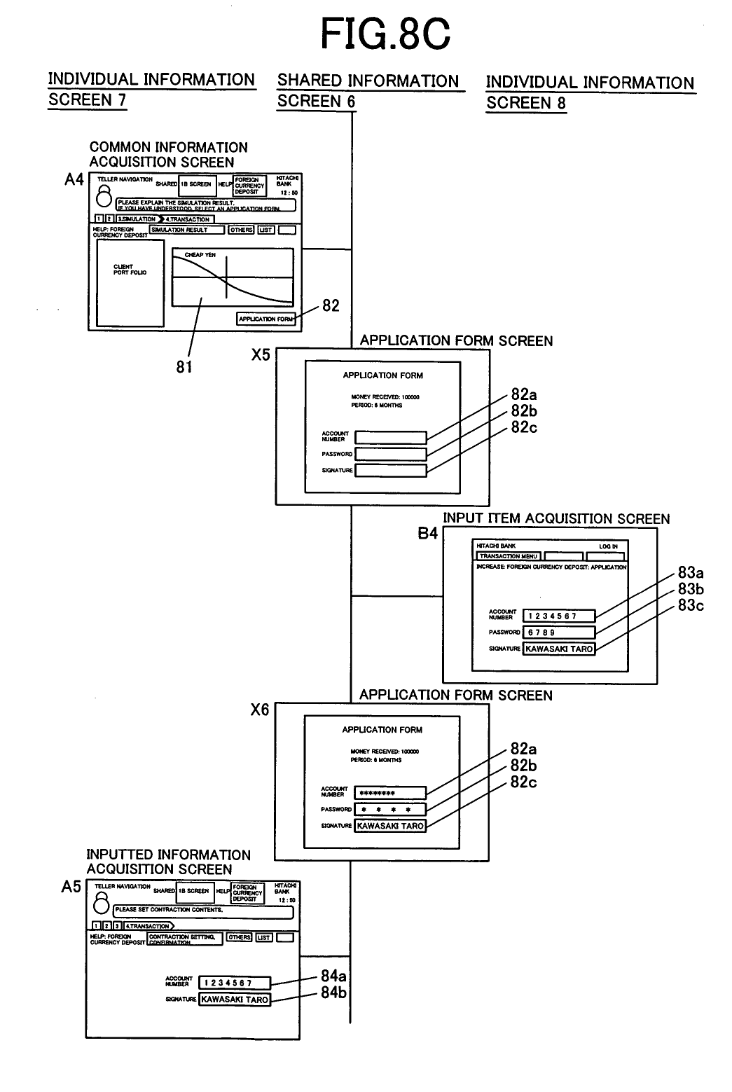

Next, explanation will be given on the operation of the first embodiment with reference to FIG. 7 and FIG. 8.

In FIG. 7, when the power supply switch is turned on directly or via a remote control operation (step 100), the CPU 40 (FIG. 6) starts operations and sets the first display 32 to the display ON state (step 101), and information for system start is displayed (step 102). Firstly, an operator 11 (FIG. 1, a bank staff in this case who is referred to as a first operator) makes the individual information screen 7 display an authentication screen (step 103). When the first operator 11 performs information input for authentication (hereinafter, referred to as authentication procedure) by using the authentication operation unit 51 (FIG. 6), the security controller 39 (FIG. 6) performs authentication operation. When the first operator 11 is authenticated (step 104), the CPU 40 reads individual information from the individual information DB 47, operates the display control section 37, supplies the information to the first display 32, and causes the individual information screen 7 to display the operator information screen for operating the shared display 31 (FIG. 6) (step 105). When the touch sensor 34 is touched to select the shared display 31 on the operator information screen (step 106), the operation controller 43 (FIG. 6) reports it to the CPU 40. The CPU 40 operates the display control section 37 and sets the shared display 31 (FIG. 6) to the display ON state. Thus, the shared information screen 6 (FIG. 1) enters the state in which the top screen is displayed (step 201).

Moreover, when the share display 31 is selected, the CPU 40 reads the next individual information of the first display 32 from the individual information DB 47, operates the display control section 37, and causes it to display the individual information of the first display 32. Thus, the individual information screen 7 displays a client selection screen Al (FIG. 8A) for selecting an operator using the individual information screen 8 (a client in this case who will be referred to as a second operator) 12 (FIG. 1) (step 107). In this client selection screen A1, the item 70 is a “client list” and a list 71 of clients coming is displayed. When one of the clients (for example, KAWASAKI Taro) is selected by touching the touch sensor 34 (step 108), the CPU 40 sets the second display 33 to display ON state (step 301). For example, a general information display screen B1 (FIG. 8A) having a transaction menu for selecting a transaction is displayed on the individual information screen 8 (FIG. 1) (step 302).

Simultaneously with this, shared information on the second operator 12 selected is read from the shared information DB of the internal storage section 44 by the CPU 40. By operating the display control section 37, the information is supplied to the shared display 31, so that a client guide screen X1 (FIG. 8A) for the selected second operator (KAWASAKI Taro in this case) 12 is displayed on the shared information screen 6 (FIG. 1) (step 202). Moreover, for the first and the second operator 11, 12, it is possible to select necessary information among the information displayed on the individual information screen 7, 8 by touching the touch panel and display it on the shared display 31.

It should be noted that in the operation below, the CPU 40 reads information from the individual information DB 47 and the shared information DB 48 of the internal storage section 44, operates the display control section 37, supplies the information to the first and the second display 32, 33 and the supply display 31 so as to cause screen display. In the explanation below, such an operation of the CPU is omitted excluding a case when necessary.

When the second operator 12 performs touch operation to select a predetermined transaction on the general information display screen B1 displayed on the individual information screen 8 of the second display 33, the authentication screen of the second operator 12 is displayed (step 303). Here, the second operator 12 performs a predetermined authentication procedure by using the authentication operation unit 51. The security controller 39 performs authentication by using the authentication information in the authentication DB 46 of the internal storage section 44. When the second operator 12 is authenticated (step 304), individual information of the second operator 12 (such as information on an account) is read from the individual information DB 47 and supplied to the second display 33. The information is displayed on the individual information screen 8, with the item 75 as “outstanding balance information”, as the individual information display screen B2 (FIG. 8A) representing the content (outstanding balance of each account) 76 of the personal information on the second operator 12 (step 305).

Moreover, individual information representing the contents of consultation of the second operator selected is read from the individual information DB 47. The individual information which has been read is supplied to the first display 32. The client information screen A2 (FIG. 8A) indicating the individual information 73 of the selected second operator 12 and a question content 74 is displayed on the individual information screen 7 with menu “1. client information confirmation” in the menu column 72 (step 110). In this client information screen A2. other information on the person (family, account, etc) can also be displayed. Simultaneously with display of the client information screen A2, the CPU 40 reads predetermined information from the shared information DB 48 and supplies it to the shared display 331 without requiring touch operation of the touch sensor 34. This is the share display information selection operation of step 111. Thus, a client-related information screen X2 (FIG. 8A) is displayed for notifying that the question (for example, a question on foreign currency deposit) of the second operator is guided to the shared information screen 6 (step 203). On the client-related information screen X2, explanation information 78 on the foreign currency deposit is displayed. Such general information can be acquired from the Internet via the network server 60 (FIG. 6).

It should be noted that in the menu column 72 of the client information screen A2, the next menu is displayed. Here, the next menu is “2. question item/answer”.

When the “2. question item/answer” in the menu column 72 is touched in the client information screen A2, if shared advice information is present for the question of the second operator 12, the information is acquired from the individual information DB 47 of the internal storage section 44 and supplied to the display 32. The individual information screen 7 displays a shared advice information present screen A3 (FIG. 8B) (step 112). The shared advice information present screen A3 such as a screen comparing Australian dollar and other dollar is created in advance by the first operator 11 who is a bank staff for advice to the questioner. When the comparison screen can be shared by the second operator 12, it is displayed. This shared advice information present screen A3 has a “comparison screen” button 79 for selecting the comparison screen. It should be noted that in the menu column 72 of the client information screen A2, the next menu “simulation” is also displayed.

When the “comparison screen” button 79 is touched (step 113), the information on the comparison screen is read out from the individual information DB 47 and supplied to the shared display 31. The shared advice screen X3 containing the comparison screen 80 is displayed in the shared information screen 6 (step 204). Thus, the shared advice screen X3 can be viewed by both of the operators 11 and 12.

On the other hand, when the “account menu” button 77 is touched on the personal information display screen B2 (FIG. 8A) displayed on the individual information screen 8, the account menu screen is displayed. By entering a predetermined keyword on this screen, it is possible to acquire predetermined information from the Internet. In order to acquire a matter for questioning the first operator (bank staff), for example, if keywords such as “increase”, “foreign currency deposit”, “simulation” are inputted, information on the simulation indicating the business climate of high yen to be questioned to the first operator by the second operator (client) is acquired from the Internet via the network server 60 (FIG. 6). The question screen B3 containing the simulation 81 displayed as one window is displayed on the individual information screen. When the simulation 81 is information to be provided to a general user, the question screen 3 is the shared information present screen and a “range selection” button 82 indicating that the simulation 81 can be shared information is displayed on the shared information present screen B3 (step 306).

When the “range selection” button 82 is touched to indicate that the simulation 81 is the question content to the first operator (step 307), the display control section 37 (FIG. 6) operates under control of the CPU 40 and information on the simulation 81 of the shared information present screen B3 is transmitted to the shared display 31. Thus, the shared information screen 6 displays a question/answer screen X4 including the comparison screen 80 from the shared advice information present screen A3 displayed on the individual information screen 7 and the simulation 81 from the shared information present screen B3 displayed on the individual information screen 8 (step 205). Thus, the first operator can know the question of the second operator and the second operator can know the answer.

Here, the simulation 81 from the question screen B3 in the individual information screen 8 displayed in the question/answer screen X4 (1) may be permitted to be displayed only in the shared information screen 6, or (2) may be shared by a bank staff, or (3) may be shared by a particular bank staff and a client. In the case of (1), it is impossible to acquire the information as the individual information in the individual information screen 7 to the first display 32 or store the information I the individual information DB 47. It is impossible to store the information as the shared information of the shared information screen 6 in the shared information DB 48, either. In the case of (2), it is possible to acquire the information as the individual information in the individual information screen to the first display 32 and store it in the individual information DB 47 as well as to store it as shared information in the shared information DB 48. In the case of (3), when acquiring the information as the individual information in the individual information screen 7 or storing it in the individual information DB 47, it is necessary to authenticate the bank staff.

When the simulation 81 displayed on the question/answer screen X4 is in the case of (2), if the first operator wants it to be individual information, he/she touches the next menu “simulation” in the menu column 72 of the shared advice information present screen A3. By this operations, the simulation 81 in the question/answer screen X4 of the shared information screen 6 is specified (step 114) and the information on the simulation 81 is transmitted from the shared display 331 to the first display and the shared information acquisition screen A4 (FIG. 8C) representing the simulation 81 is displayed on the individual information screen 7 of the first operator 11 (step 115).

The first operator checks the content of the shared information acquisition screen A4 (step 116) and touches the “application form” button 82 displayed on the shared information acquisition screen A4 (step 117). The “application form” information as shared information in the shared information DB 48 is read and supplied to the shared display 31, and the shared information screen 6 displays an application form screen X5 representing an application form having input columns 82a such as an account number, a password, and a signature (step 206). Simultaneously with this, the screen information for inputting information into the application form is read from the individual information DB 47 and supplied to the second display 33 and the individual information screen 8 of the second operator displays the input item acquisition screen B4 (FIG. 8C) (step 308). When an account number, a password, and a signature are input to the input items 83a to 83c of the input item acquisition screen B4 (step 309), the input information is sent to the shared display 31 and the first display 32, and the shared information screen 6 displays the application form screen X6 (FIG. 8C) displaying the input information on the respective items 82a to 82c (the account number and the password are displayed by using the asterisks) (step 207). The individual information screen 7 also displays an input completion information acquisition screen A5 (FIG. 8C) directly displaying the input information on the items 84a and 84b (step 118).

By the aforementioned operation, for example, the procedure for foreign currency account is completed. When the second operator performs a touch operation for termination on the individual information screen 8 (step 310), display of the information on the simulation 81 transmitted to the shared display from the second display 33, on the shared information display 6 is cancelled (step 208). On this shared information screen 6, the same screen as the share advice screen X3 displaying the comparison screen 80 from the first display 32 is displayed (step 209). When the first operator 11 performs a touch operation to turn off the display of the second display 33 on the individual information screen 7 (step 119), display of the individual information screen 8 is turned off (step 311). Moreover, when the first operator 11 performs a touch operation to turn off display of the shared display 31 on the individual information screen 7 (step 120), the display of the shared information screen 6 is turned off (step 210). Furthermore, when the power is turned off by the power switch or the remote controller (step 121), the display of the individual information screen 7 is turned off (step 122) and the power is turned off.

It should be noted that in the aforementioned case, the shared information provided to the shared information screen 6 from the individual information screen 8 of a client is acquired by the individual information screen 7 of a bank staff. However, it is also possible to acquire the shared information provided to the shared information screen 6 from the individual information screen 7 of the bank staff to the individual information screen 8 of the client.

As has been described above, in the first embodiment, each operator can display the necessary individual information in his/her individual information screen 7, 8 and these individual information can be displayed on the shared information screen 6, if necessary, by the operator owning the information so that the information is provided to the partner operator. Moreover, the individual information on the respective individual information screen 7, 8 cannot be viewed by the other operator. Accordingly, the operator can display the individual information necessary for the individual information screen to be operated without worrying about the partner. Thus, it is possible to smoothly perform the business negotiation, consultation, and conference.

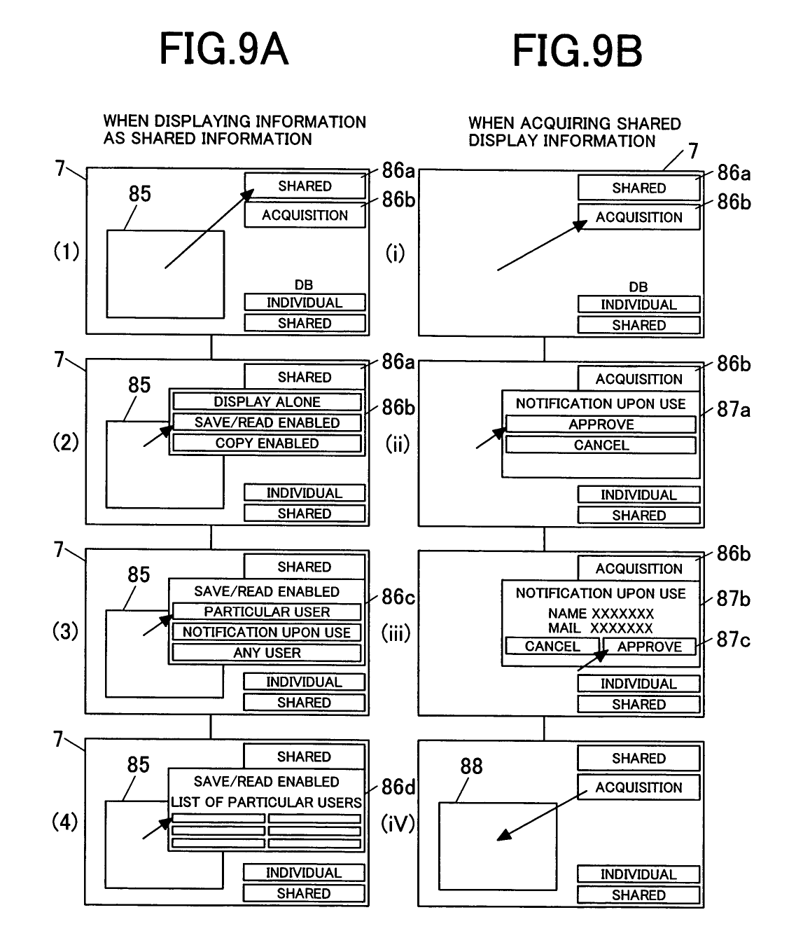

FIGS. 9A and 9B show another specific example of shared information passing between the individual information screens 7, 8 and the shared information screen 6 and show essential portions of the individual information screen. FIG. 9A takes an example of the individual information screen 7 and shows the operation procedure to display the shared information in the individual information screen on the shared information screen 6. Moreover, FIG. 9B takes an example of the individual information screen 7 and shows the operation procedure to acquire the shared information displayed on the shared information screen 6 to an individual information screen.

Firstly, referring to FIG. 9A, explanation will be given on the case when the information in the individual information screen 7 is displayed on the shared information screen 6.

When a screen capable of handling shared information (such as the client information screen A2 (FIG. 8A)) is displayed on the individual information screen 7, as shown in (1), the “shared” button 86a and the “acquisition” button 86b are displayed at the right side of the individual information screen 7. Moreover, in this case, the information handled as shared information (hereinafter, this will be also called shared information) 85 is displayed. When displaying this shared information 85 on the shared information screen 6, the “shared” button 86a is touched. Then, as shown in (2), a menu list 86b for defining the use form of the shared information 85 is displayed.

In this list 86b, for example, menu “display alone”, “storage/read enabled”, and “copy enabled” are displayed. The menu “display alone” permits only display of the shared information 85 on the shared information screen 6. The menu “storage/read enabled” permits to display the shared information 85 on the shared information screen 6 and permits the other individual information screen (the individual information screen 8 in this case) to store the information in the individual information DB 47 (FIG. 6) and read it (that is, the information can be handled as individual information of the operator of the individual information screen 8). When this menu is touched, as shown in (3), the “storage/read enabled” list 86c is displayed as submenu “particular user”, “notification upon use”, and “any user” so as to specify a user who can perform the storage/read. The submenu “particular user” permits only a particular user to store/read the shared information 85. The submenu “notification upon use” decides whether to permit storage/read of the shared information when the user makes notification. The submenu “any user” permits any of the users to store/read the shared information 85. For example, when the submenu “particular user” in the “storage/read enabled” list 86c is touched and selected, as shown in Fig. (4) a particular user list 86d is displayed to specify the user who can store/read the shared information 85.

Referring to FIG. 9B, explanation will be given on the case when the shared information in the shared information screen 6 is displayed on an individual information screen.

Like the case (1) of FIG. 9A, when a screen capable of handling shared information (such as the shared information acquisition screen A4 (FIG. 8C)) is displayed on the individual information screen 7, as shown in (i), the “shared” button 86a and the “acquisition” button 86b are displayed at the right side of the individual information screen 7. When the shared information displayed in the shared information screen 6 is to be acquired, the “acquisition” button 86b is touched. Here, as shown in FIG. 9A (3), if the “notification upon use” is specified for the shared information displayed on the current shared information screen 6 and to be acquired and if the “acquisition” button 86b of the individual information screen 7 shown in (i) is selected, a selection screen 87 for selecting whether to notify is displayed as shown in (ii). This selection screen 87a has the “approval” button and the “cancel” button. When the shared information is to be acquired, the “approval” button is touched. Then, as shown in (iii), the operator personal information 87b such as a user name and mail address is displayed by using the individual information in the individual information DB 47. When the “approval” button 87c is touched, as shown in (iv), the shared screen 88 in the shared information screen 6 is displayed on the individual information screen 7.

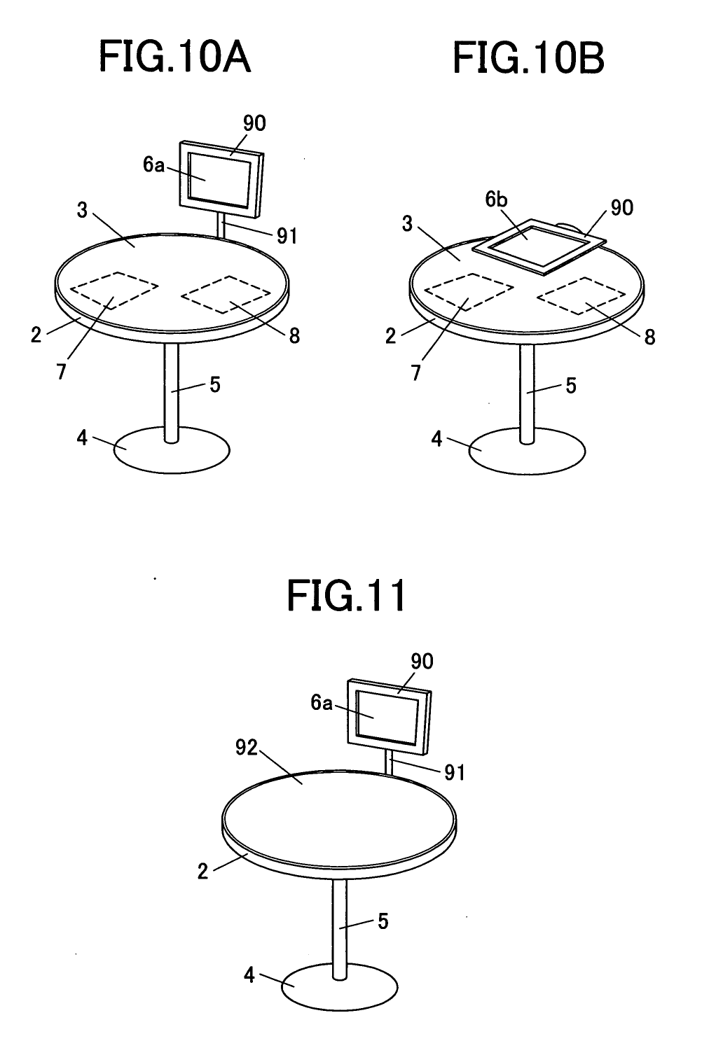

Figs. 10A and 10B are perspective views of the table-shaped information terminal according to a second embodiment of the present invention. The reference symbols 6a, 6b denote shared information screens, 90 denotes a shared display, and 91 denotes a support section. Those sections corresponding to the sections in FIG. 1 are denoted by the same reference symbols and their explanations are omitted.

In FIG. 10A, like the first embodiment shown in FIG. 1, on the table surface 3 of the communication table 2, the individual information tables 7, 8 can be displayed. Moreover, the shared display 90 is attached to the end surface of the communication table 2 via a support section 91. The shared display 90 has a display surface at the side of the individual information screens 7, 8. The display surface is arranged to be vertical to the table surface 3 or slightly inclined upward or downward with respect to the vertical surface and the shared information screen 6a is displayed here.

The shared information screen 6a is similar the share information screen 6 in the first embodiment and the operators of the individual information screens 7, 8 can share the information displayed on the shared screen 6a.

As a specific example of the shared display 90, the support section 91 may be collapsible and, as shown in FIG. 10B, the support section 91 may be inclined toward the individual information terminals 7, 8 and the shared display 90 may be placed on the table surface 3.

In this case, the shared display 90 has two display surfaces, one on the front surface and the other on the rear surfaces. One of the display surfaces displays the shared information screen 6a toward the individual information screens 7, 8 while the other display surface displays the shared information screen 6b toward the opposite side. As shown in FIG. 10A, when the support section 91 is vertical to the table surface 3, the shared information screen 6a is displayed on the display surface of the side of the individual information screens 7, 8 so that it can be viewed by the operators of the individual information screens 7, 8. Moreover, when the support section 91 is bent and placed on the table surface 3 of the shared display 90 as shown in FIG. 10B, the display surface of the other side is directed upward and the shared information screen 6b is displayed here. Thus, in the state shown in Fig. 10B, the shared information screen 6b can be viewed by the operators of the individual information screens 7, 8. The shared information screen 6b can be displayed so that it can be viewed by the operators standing and the shared information screens 6a, 6b may have a touch panel function. Moreover, instead of the display having the two display surfaces, the display surface may be provided only on the front side if the support section can slide the display to the substantially horizontal position. By arranging the display substantially horizontal on the table surface, operators can easily perform touch operation.

It should be noted that here two individual information screens are displayed but like the first embodiment, three or more screens may also be displayed.

Moreover, except for the aforementioned configurations, the second embodiment has the same configuration as the first embodiment explained with reference to FIG. 1 to FIG. 9 and can obtain the same effect as the first embodiment. Furthermore, the shared information screen 6a can be arranged to be almost vertical to the table surface 3 and it can be viewed easily.

FIG. 11 is a perspective view showing a table-shaped information terminal according to a third embodiment of the present invention. The reference symbol 92 denotes a display screen of an individual display. Those portions identical to the corresponding portions in FIG. 10 are denoted by the same reference symbols and their explanations are omitted.

In FIG. 11, the entire communication table 2 is an individual display and the entire table surface is the display surface 92 of the individual display. Except for this, the configurations are identical to those of the second embodiment shown in FIG. 10.

In the third embodiment having the aforementioned configuration, when an operator (the aforementioned bank staff or client) approaches toward the position of the communication table 2, the display screen 92 displays the individual information screen.

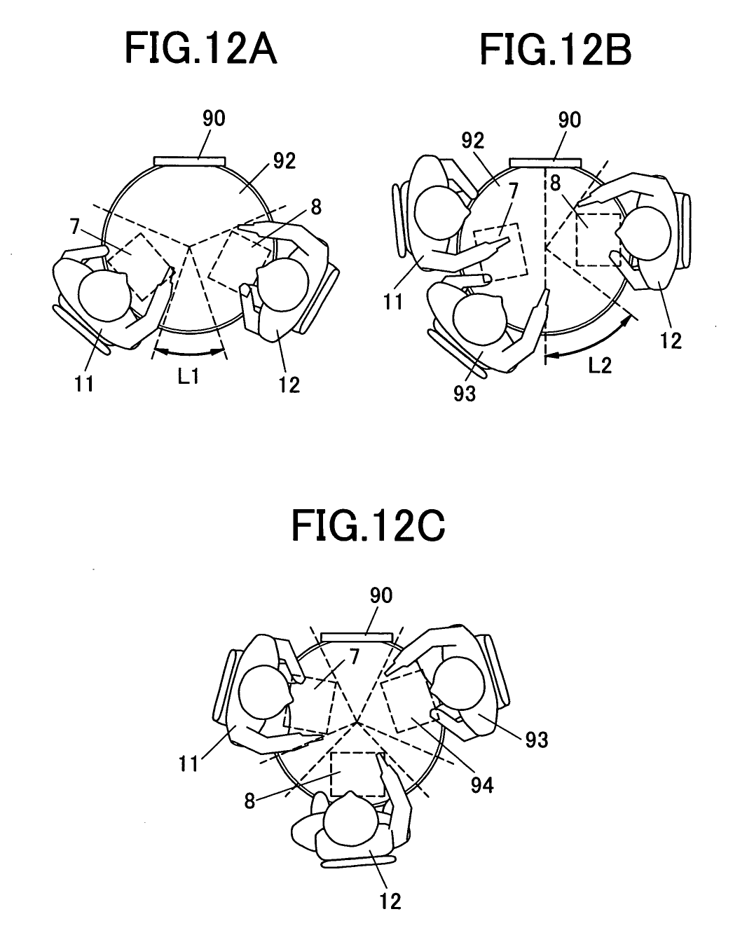

For example, as shown in FIG. 12A, when two operators 11, 12 approach the communication table 2 and the operators 11, 12 are at a distance L1 or farther from each other, the individual display operates and individual information screens 7, 8 are displayed on the display screen 92 almost opposing to the operators 11, 12. Moreover, when three operators 11, 12, 93 approach the communication table 2, as shown in FIG. 12B, if two operators 11, 93 are at a distance smaller than the aforementioned predetermined interval L1, one individual information screen 7 is displayed on the display screen 92 so as to identically oppose to the operators 11, 93, and when the operator 12 is apart from the operators 11, 93 at a distance L2 greater than the predetermined interval L1, an individual information screen 8 is displayed to oppose to the operator 12. This corresponds to a case when the operator 12 is a bank staff who gives an advice and the operator 93 is a person (such as a family member) accompanying the operator 11 who consults with the bank staff. When the three operators are apart from one another by a distance greater than the predetermined interval L1, as shown in FIG. 12C, the individual information screens 7, 8, 94 are displayed for each of them.

Thus, when the entire table surface of the communication table 2 is used as display surface 92 of the individual display and the individual information screens are displayed at arbitrary positions, it is possible to use a filed-of-view angle control filter on the display screen 92 so that the contents of the individual information screen cannot be viewed by the other individual information screen operator.

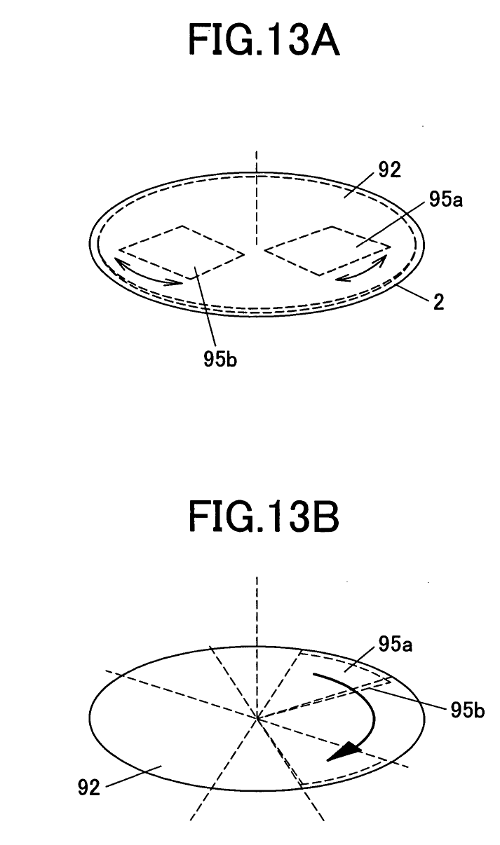

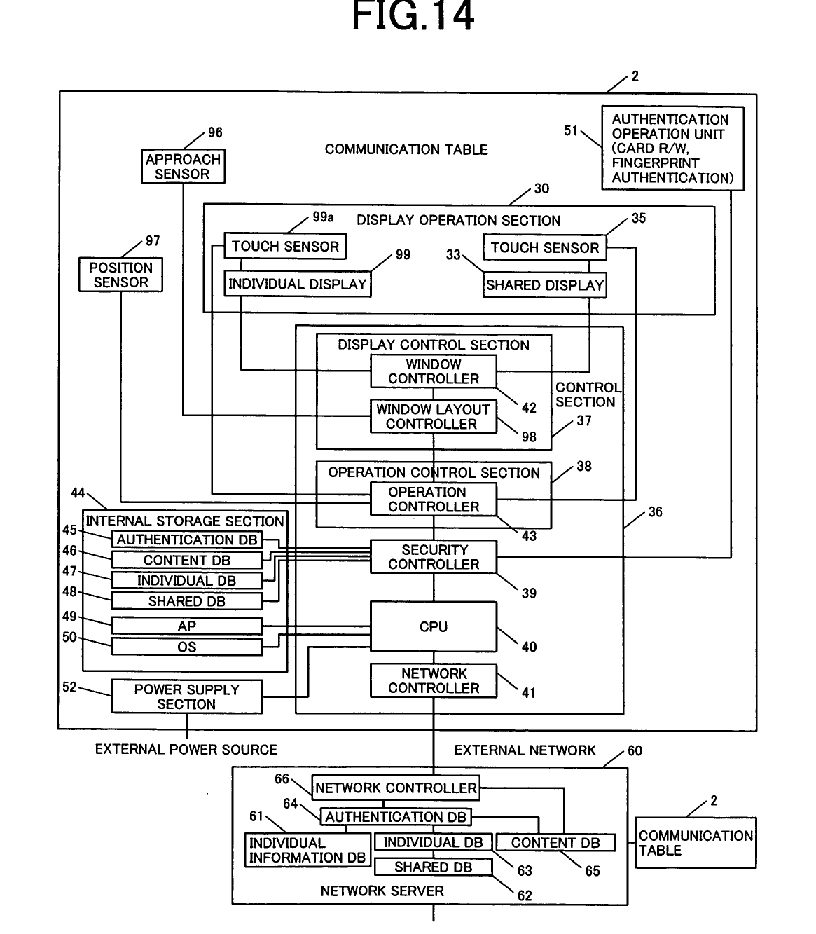

Moreover, as another method, as shown in FIG. 13, the field-of-view angle control filters 95a, 95b for the number (here, two) of the individual information screens which can be displayed are arranged in the communication table 2 at a distance from each other. The positions of the field-of-view angle control filters 95a, 95b can be adjusted along the same circumference in the communication table 2. When an individual information screen is displayed, the field-of-view angle control filter 95a or 95b nearer to the screen is position-adjusted so as to be superimposed with the display area of the individual information screen. Thus, there is no need of arranging the field-of-view angle control filter over the entire table surface of the communication table.

Furthermore, as the other method, as shown in FIG. 13B, when the communication table 2 is not used, field-of-view angle control filters 95a, 95b for the number of individual information screens which can be displayed on the communication table 2 are stacked at a predetermined position of the communication table 2. When an individual information screen is displayed on the display screen, one field-of-view angle control filter 95a moves so as to be superimposed with the display area of the individual information screen displayed. Thus, each time an individual information screen is displayed, the field-of-view filter moves to the display area. Thus, there is no need of arranging the field-of-view angle control filter over the entire table surface of the communication table.

FIG. 14 is a block diagram showing a specific example of circuit arranged in the communication table 2 shown in FIG. 11. The reference symbol 96 denotes approach sensors, 97 denotes a position sensor, 98 denotes a window layout controller, 99 denotes an individual display, and 99a denotes a touch sensor. The portions corresponding to the portions of FIG. 6 are denoted by the same reference symbols and their explanations are omitted.

In FIG. 14, the approach sensors 96 detect an approach of an operator to the communication table 2 and a plurality of approach sensors 96 are arranged at a predetermined interval at the circumference of the communication table 2. The window layout controller 98 of the display control section 37 detects a position of the communication table 2 where the operator approaches from the detection output of the approach sensors and sends the position detection information to the window controller 42. The window controller 42 drives the individual display 99 and displays an individual information screen at the position of the display screen 92 corresponding to the position detection information. Thus, as has been explained with reference to FIG. 12, the individual information screens 7, 8, 94 or the like are displayed on the display screen 92.

Moreover, the position sensor 97 detects the position of the field-of-view angle control filters 95a, 95b explained with reference to FIG. 13. Although not depicted, when the position of the individual information screen displayed by the window layout controller 98 is detected, the operation controller 43 of the operation control section 33 moves the field-of-view angle control filters 95a, 95b to this position. By using the position information on the field-of-view angle control filters 95a, 95b detected by the position sensor 97 and position information on the individual information screen from the window layout controller 98, the field-of-view angle control filters 95a, 95b are matched with the display area of the individual information screen.

Thus, it is possible to set the field-of-view angle control filters 95a, 95b for each of the individual information screens on the display screen.

It should be noted that when the field-of-view angle control filter is arranged over the entire surface of the display screen 92, the position sensor 97 is not required.

Moreover, the touch sensor 99a in this case makes the entire surface of the display screen 92 have the touch panel function.

It should be further understood by those skilled in the art that although the foregoing description has been made on embodiments of the invention, the invention is not limited thereto and various changes and modifications may be made without departing from the spirit of the invention and the scope of the appended claims.

1. A method for displaying and operating a table-shaped information terminal comprising the steps of:
displaying individual information screens and a shared information screen which are subject to a plurality of screen operations, on a surface of a table,
deciding a part of individual information displayed on the individual information screen, and
displaying the decided part of the individual information on the shared information screen.

2. A table-shaped information terminal operation/display method as claimed in claim 1, wherein the individual information screen and the shared information screen are respectively displayed in indentations arranged on the table surface and the shared information screen is slightly inclined in the indentation so as to face the individual information screen side.

3. A table-shaped information terminal operation/display method comprising the steps of:
displaying an individual information screen which can be subjected to a plurality of operations, on a flat table surface of a table;
providing a shared display having a display surface almost vertical to the table surface;
displaying a shared information screen on the shaped display;
deciding a part of the individual information displayed on the individual information screen, and
displaying the decided part of the individual information displayed on the individual information screen as shared information on the shared information screen.

4. A table-shaped information terminal operation/display method as claimed in claim 3, wherein the shared display has two display surfaces, i.e., a front surface and a rear surface and the display surfaces may be selected to be almost vertical to the table surface or to be parallel to the table surface when the shared display is on the table surface.

5. A table-shaped information terminal operation/display method as claimed in claim 1, wherein
the table surface provides a single display surface and has approach detection means for detecting approach of an operator operating the individual information screen; and
the individual information screen is displayed at the position of the table surface opposing to the approach position of the operator detected by the approach detection means.

6. A table-shaped information terminal operation/display method as claimed in claim 5, wherein when operators approaching the table surface are at a distance greater than a predetermined interval from each other, the individual information screen is displayed on the table surface for each of the operators.

7. A table-shaped information terminal operation/display method as claimed in claim 1, wherein the individual information screen has means for narrowing the field-of-view angle so that individual information displayed on the individual information screen cannot be viewed by the operator of the other individual information screen.

8. A table-shaped information terminal operation/display method as claimed in claim 5, wherein
means for narrowing the field-of-view angle is movably arranged for each of the individual information screens which can be displayed on the table surface; and
the means for narrowing the field-of-view angle are moved to be set to the positions where the individual information screens are displayed on the table surface.

9. A table-shaped information terminal operation/display method as claimed in claim 1, wherein
one of the individual information screens is a particular individual information screen which is displayed on the table surface by operation of power turning ON and by the screen operation on the particular individual information screen, the other individual information screen and the shared information screen are displayed.

10. A table-shaped information terminal operation/display method as claimed in claim 1, wherein
the entire table surface is a single display screen and has approach detection means for detecting approach of an operator of the individual information screen, and
the individual information screen is displayed at the position of the table surface opposing to the approach position of the operator detected by the approach detection means.

11. A table-shaped information terminal operation/display method as claimed in claim 3, wherein
the entire table surface is a single display screen and has approach detection means for detecting approach of an operator of the individual information screen, and
the individual information screen is displayed at the position of the table surface opposing to the approach position of the operator detected by the approach detection means.

12. A table-shaped information terminal operation/display method as claimed in claim 4, wherein
the entire table surface is a single display screen and has approach detection means for detecting approach of an operator of the individual information screen, and
the individual information screen is displayed at the position of the table surface opposing to the approach position of the operator detected by the approach detection means.

13. A table-shaped information terminal operation/display method as claimed in claim 2, wherein
the display information screens and the shared information screen are respectively displayed in indentations arranged on the table surface and the shared information screen is slightly inclined so as to face the individual information screen side.

14. A table-shaped information terminal operation/display method as claimed in claim 3, wherein
the individual information screens have means for narrowing a field-of-view angle so that individual information displayed on the individual information screens are not viewed by the operator of the other individual information screens.

15. A table-shaped information operation/display method, wherein
the shared display has two display surfaces, i.e., a front display surface and a rear display surface and the display surfaces may be selectively set to be almost vertical to the table surface or set on the table surface so that the display surfaces are parallel to the table surface.

16. A table-shaped information terminal operation/display method as claimed in claim 6, wherein
means for narrowing the field-of-view angle is movably arranged for each of the individual information screen which can be displayed on the table surface, and
the means for narrowing the field-of-view angle are moved to be set to the positions where the individual information screens are displayed on the table surface.

17. A table-shaped information terminal display method comprising:
a first step operated by a first operator to start a first screen arranged on a table-shaped plane for displaying data on the first operator with a field-of-view angle limited so that the displayed contents can be viewed only from the operation position of the first operator;
a second step operated by a second operator to start a second screen arranged on the surface of said table-shaped plane for displaying data on the second operator with a field-of-view angle limited so that the displayed contents can be viewed only from the operation position of the second operator; and
a third step for displaying a part of the data displayed on the first screen and a part of the data displayed on the second screen.

18. A table-shaped information terminal comprising:
a first screen operated by a first operator, arranged on a table-shaped plane for displaying data on the first operator, and having a limit member for limiting the field-of-view angle so that the displayed contents can be viewed only from the operation position of the first operator;
a second screen operated by a second operator, arranged on said table-shaped plane for displaying data on the second operator, and having a limit member for limiting the field-of-view angle so that the displayed contents can be viewed only from the operation position of the second operator; and
a third screen for displaying a part of data displayed on both of the first screen and the second screen.

19. A table-shaped information terminal as claimed in claim 18, wherein the limit member has a plurality of light shielding plates arranged in the vicinity of and vertical to the screen according to the position relationship between the first and the second operator.
